(19) United States
(12) Patent Application Publication
(10) Pub. No.: US 2025/0342764 A1
(43) Pub. Date: Nov. 6, 2025

(54) PARKING MANAGEMENT SYSTEM AND METHOD

(71) Applicant: HANWHA VISION CO., LTD., Seongnam-si (KR)

(72) Inventors: Sweung Won Cheung, Seongnam-si (KR); Dae II Park, Seongnam-si (KR); Min Suk Sung, Seongnam-si (KR)

(73) Assignee: HANWHA VISION CO., LTD., Seongnam-si (KR)

(21) Appl. No.: 19/268,340

(22) Filed: Jul. 14, 2025

Related U.S. Application Data
(63) Continuation of application No. PCT/KR2023/095113, filed on Dec. 15, 2023.

(30) Foreign Application Priority Data
Apr. 5, 2023 (KR) 10-2023-0044595

(51) Int. Cl. G08G 1/14; G08G 1/127

(52) U.S. Cl. CPC G08G 1/142; G08G 1/127

(57) ABSTRACT

A parking management system includes: a detector configured to detect a target vehicle that enters a parking area and one or more other vehicles parked in the parking area; and a management processor configured to identify a parking space for the target vehicle based on parking information of the target vehicle and parking information of the one or more other vehicles. The detector includes: a first detector at a vehicle entrance of the parking area and configured to detect the target vehicle entering the parking area; and a second detector configured to detect the target vehicle moving within the parking area and the one or more other vehicles parked in the parking area.

### CROSS-REFERENCE TO RELATED APPLICATION(S)

This application is a continuation of International Application No. PCT/KR2023/095113, filed on Dec. 15, 2023, in the Korean Intellectual Property Receiving Office, which is based on and claims priority to Korean Patent Application No. 10-2023-0044595, filed on Apr. 5, 2023, in the Korean Intellectual Property Office, the disclosures of which are incorporated by reference herein in their entireties.

### BACKGROUND

### 1. Field

The present disclosure relates to a parking management system and method, and more particularly, to a parking management system and method for guiding a driver to a parking space in consideration of the driver's parking preference.

### 2. Description of Related Art

As the vehicle penetration rate increases, drivers may experience difficulty in securing a parking space. Even after entering a parking area, it may be difficult to search for an available parking space, and thus drivers may end up using a parking location that does not match their preferences.

A technology that uses a lamp light to indicate the availability of each parking space is being utilized, but even with such technology, it may not satisfy a driver's parking preference.

Accordingly, there is a need for a system that guides a driver to a parking space according to the driver's parking preference.

### SUMMARY

Provided are a parking management system and method for guiding a driver to a parking space in consideration of the driver's parking preference.

Additional aspects will be set forth in part in the description which follows and, in part, will be apparent from the description, or may be learned by practice of the presented embodiments.

According to an aspect of the disclosure, a parking management system may include: a detector configured to detect a target vehicle that enters a parking area and one or more other vehicles parked in the parking area; and a management processor configured to identify a parking space for the target vehicle based on parking information of the target vehicle and parking information of the one or more other vehicles.

The detector may include: a first detector at a vehicle entrance of the parking area and configured to detect the target vehicle entering the parking area; and a second detector configured to detect the target vehicle moving within the parking area and the one or more other vehicles parked in the parking area.

The parking information of the target vehicle may include at least one of a vehicle type of the target vehicle, driver information of the target vehicle, a destination of the target vehicle, a preferred parking space of the target vehicle, or a parking time history of the target vehicle, where the parking information of the one or more other vehicles includes a parking time history of the one or more other vehicles.

The management processor may be further configured to: determine an expected departure time of the target vehicle and an expected departure time of the one or more other vehicles based on the parking time history of the target vehicle and the parking time history of the one or more other vehicles, respectively; and identify, as the parking space, a double-parking space adjacent to a vehicle that has an expected departure time later than the expected departure time of the target vehicle, among the one or more other vehicles.

The parking management system may further include: a notifier configured to provide guidance to the parking space, where the notifier includes: a first notifier installed in each of a plurality of parking spaces provided in the parking area and configured to irradiate light in a preset color or pattern; and a second notifier configured to irradiate light onto a ground of the parking area corresponding to the parking space.

The second notifier may be further configured to irradiate, in a form of a figure, an area within a parking space or a double-parking space in the parking area at which the target vehicle is to be positioned.

The detector or the management processor may include an artificial intelligence (AI) parking manager configured to identify a parking area of a plurality of parking areas by using a trained neural network model based on parking information of a target vehicle, where the system further comprises a user terminal configured to output the identified parking area.

The AI parking manager may be further configured to provide information about a parking space at which the target vehicle is parked.

The management processor may be further configured to provide information for guiding the target vehicle to a parking area selected from among the plurality of parking areas through the user terminal.

According to an aspect of the disclosure, a parking management system may include: an artificial intelligence (AI) parking manager configured to identify a parking area of a plurality of parking areas by using a trained neural network model based on parking information of a target vehicle; and a user terminal configured to output the identified parking area.

The parking information of the target vehicle may include at least one of a vehicle type of the target vehicle, driver information of the target vehicle, a destination of the target vehicle, a preferred parking space of the target vehicle, or a parking time history of the target vehicle.

The AI parking manager may be further configured to provide information about a parking space at which the target vehicle is parked.

The parking management system may further include: a management processor configured to provide information for guiding the target vehicle to a parking area selected from among the plurality of parking areas through the user terminal.

According to an aspect of the disclosure, a parking management method may include: detecting a target vehicle that enters a parking area and one or more other vehicles parked in the parking area; and identifying a parking space for the target vehicle based on parking information of the target vehicle and parking information of the one or more other vehicles.

The detecting the target vehicle may include: detecting the target vehicle entering the parking area; and detecting the target vehicle moving within the parking area.

The parking information of the target vehicle may include at least one of a vehicle type of the target vehicle, driver information of the target vehicle, a destination of the target vehicle, a preferred parking space of the target vehicle, or a parking time history of the target vehicle, where the parking information of the one or more other vehicles includes a parking time history of the one or more other vehicles.

The identifying the parking space for the target vehicle may include: determining an expected departure time of the target vehicle and an expected departure time of the one or more other vehicles based on the parking time history of the target vehicle and the parking time history of the one or more other vehicles, respectively; and identifying, as the parking space, a double-parking space adjacent to a vehicle that has an expected departure time later than the expected departure time of the target vehicle, among the one or more other vehicles parked in the parking area.

The parking management method may further include: irradiating light in different colors based on whether the one or more other vehicles are parked in respective parking spaces among a plurality of parking spaces provided in the parking area; and irradiating light onto a ground of the parking area corresponding to the parking space.

The irradiating light onto the ground of the parking area corresponding to the parking space may include irradiating, in a form of a figure, an area within a parking space or a double-parking space in the parking area at which the target vehicle is to be positioned.

According to an aspect of the disclosure, a parking management method may include: identifying one of a plurality of parking areas using a trained neural network based on parking information of a target vehicle; and outputting the identified parking area.

The parking information of the target vehicle may include at least one of a vehicle type of the target vehicle, driver information of the target vehicle, a destination of the target vehicle, a preferred parking space of the target vehicle, or a parking time history of the target vehicle.

The parking management method may further include: providing information about a parking space at which the target vehicle is parked.

The parking management method may further include: providing information for guiding the target vehicle to a parking area selected from among the plurality of parking areas through a user terminal.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating a parking management system according to an embodiment of the present disclosure;

FIG. 2 is a view showing a parking area according to an embodiment of the present disclosure;

FIG. 3 is a view for explaining the operation of a management processor according to an embodiment of the present disclosure;

FIG. 4 is a view for explaining guidance to a parking space using a first notifier when there are no other vehicles according to an embodiment of the present disclosure;

FIG. 5 is a view for explaining guidance to a parking space using the first notifier when other vehicles are present according to an embodiment of the present disclosure;

FIG. 6 is a view for explaining guidance to a parking space using a second notifier when there are no other adjacent vehicles according to an embodiment of the present disclosure;

FIG. 7 is a view for explaining guidance to a parking space using the second notifier when other vehicles are present according to an embodiment of the present disclosure;

FIG. 8 is a view for explaining guidance to a parking space using the second notifier according to an embodiment of the present disclosure;

FIG. 9 is a view for explaining formation of a guide pattern on the ground of the parking area according to an embodiment of the present disclosure;

FIG. 10 is a view for explaining how the management processor manages a plurality of parking areas according to an embodiment of the present disclosure;

FIG. 11 is a block diagram of an artificial intelligence (AI) parking manager according to an embodiment of the present disclosure;

FIG. 12 is a block diagram of an artificial intelligence computer according to an embodiment of the present disclosure;

FIG. 13 is a view illustrating a screen of a user terminal indicating a recommended parking area according to an embodiment of the present disclosure; and

FIG. 14 is a view illustrating a screen of a user terminal indicating the parking space of a target vehicle according to an embodiment of the present disclosure.

### DETAILED DESCRIPTION

Example embodiments will hereinafter be described in detail with reference to the accompanying drawings. Certain advantages and features of the present disclosure, as well as methods of achieving them, will become apparent by referring to the embodiments described below in detail in conjunction with the accompanying drawings. However, the present disclosure is not limited to the embodiments disclosed below but can be implemented in various forms. The embodiments are merely provided to ensure the completeness of the disclosure and to fully convey the scope to those skilled in the art to which the disclosure pertains. Throughout the specification, the same reference numerals refer to the same components.

Unless otherwise defined, all terms (including technical and scientific terms) used herein may have meanings commonly understood by those skilled in the art to which the present disclosure pertains. Moreover, terms generally defined in dictionaries are not to be interpreted in an idealized or excessively formal sense unless explicitly defined otherwise.

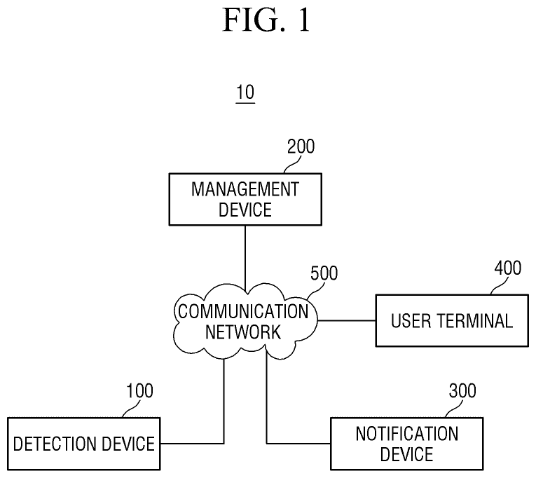

FIG. 1 is a view illustrating a parking management system according to an embodiment of the present disclosure.

Referring to FIG. 1, a parking management system 10 may include a detector 100, a management processor 200, a notifier 300, a user terminal 400, and a communication network 500.

The detector 100 may perform the function of detecting a target vehicle that has entered a parking area and other vehicles that are parked in the parking area. Here, the target vehicle refers to a vehicle for which a parking space recommendation is provided, and the other vehicles refer to vehicles that are already parked in the parking area before the target vehicle enters.

The detector 100 may detect the target vehicle and the other vehicles through an image. For example, a camera may perform the role of the detector 100. However, image-based detection of the target vehicle and the other vehicles is merely exemplary. According to some embodiments of the present disclosure, the detector 100 may detect the target vehicle and the other vehicles through a separate communication with the target vehicle and the other vehicles. The following description will primarily focus on an embodiment in which the detector 100 detects the target vehicle and the other vehicles through an image. The detector 100 may include one or a plurality of cameras. The detector 100 may have a function of recording a monitored area or taking a picture. The detector 100 may utilize a trained neural network for performing objection detection and objection recognition functions.

The management processor 200 may receive the result of vehicle detection from the detector 100. The management processor 200 may perform the function of recommending (e.g., identifying) a parking space for the target vehicle with reference to parking information of the target vehicle and parking information of the other vehicles. For example, the management processor 200 may recommend a space that matches the preference of the target vehicle's driver, or recommend a space adjacent to a specific other vehicle.

The notifier 300 may perform the function of notifying the driver of the target vehicle of the parking space recommended by the management processor 200. For example, the notifier 300 may irradiate light in a specific color to indicate the recommended parking space or may form a road surface pattern on the ground to guide the target vehicle to the recommended parking space. The notifier 300 may be implemented as one or more light-emitting diodes (LEDs), which may be arranged or installed to create various patterns or shapes, and/or may be implemented as one or more beam projectors which uses a light source to project various images, shapes, or the like.

The user terminal 400 may be a portable terminal owned by the driver of the target vehicle. In an embodiment, the user terminal 400 may be installed in the target vehicle. For example, a navigation device or a separate display device installed in the target vehicle may serve as the user terminal 400. The user terminal 400 may receive and output the recommended parking space from the management processor 200. The driver of the target vehicle may identify the recommended parking space through the user terminal 400.

The communication network 500 may relay communication among the detector 100, the management processor 200, the notifier 300, and the user terminal 400. The communication network 500 may include a wired network such as local area networks (LANs), wide area networks (WANs), metropolitan area networks (MANs), and integrated service digital networks (ISDNs), etc., a wireless network including wireless Internet such as 3G, 4G (LTE), 5G, Wi-Fi, Wireless Internet such as Wibro, Wimax, etc. a wireless network including short-distance communication and short distance networks, such as Bluetooth, radio frequency identification (RFID), Infrared Data Association (IrDA), Ultra Wideband (UWB), ZigBee, Near field communication (NFC), etc. In wireless mobile communication, a communication network may further include a component such as a base transceiver station (BTS), a mobile switching center (MSC), a home location register (HLR), an access gateway that enables transmission and reception of wireless packet data, and a packet data serving node (PDSN). The scope of the present disclosure is not limited thereto.

The above description illustrates the detector 100 and the management processor 200 as separate entities. However, according to some embodiments of the present disclosure, the management processor 200 may be included in the detector 100. As will be described later, the parking management system 10 may include a plurality of detectors 100, and at least one of the plurality of detectors 100 may include the management processor 200. In such a case, the plurality of detectors 100 may perform detection and recognition of the target vehicle and directly recommend a parking space for the target vehicle. The following description will explain the detector 100 and the management processor 200 as separate entities, but the disclosure is not limited thereto.

Each of the detector 100, the management processor 200, the notifier 300, and the user terminal 400 according to embodiments of the present disclosure may include one or more processors. The one or more processors may include one or more of a central processing unit (CPU), a many integrated core (MIC), a field-programmable gate array (FPGA), a digital signal processor (DSP), a hardware accelerator, etc. The one or more processors are able to perform control of any one or any combination of the other components connected via the network, and/or perform an operation or data processing relating to communication. The one or more processors may execute one or more programs stored in a memory.

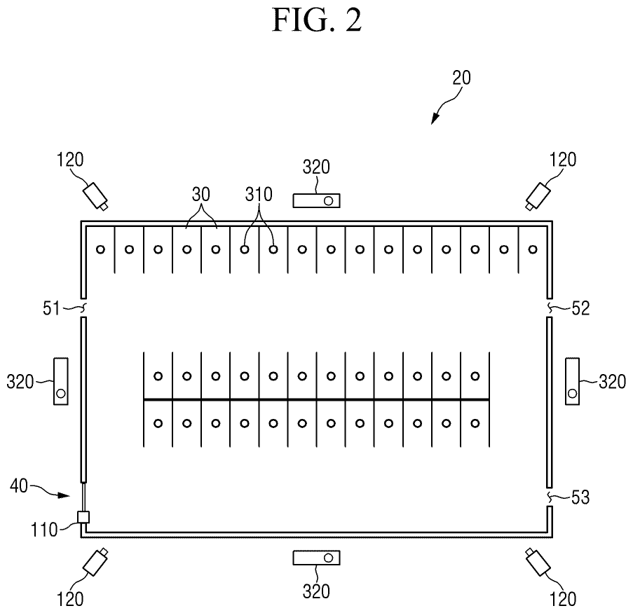

FIG. 2 is a view illustrating a parking area according to an embodiment of the disclosure.

Referring to FIG. 2, the detector 100 and the notifier 300 may be provided in a parking area 20.

The parking area 20 may include a plurality of parking spaces 30. Each parking space 30 represents a region of a predetermined size designated for parking a vehicle, and the boundaries of each parking space 30 may be defined by parking lines.

The parking area 20 may include one or more pedestrian entrances 51 through 53. After parking their vehicles, the drivers of the target vehicle and the other vehicles may exit the parking area 20 through the pedestrian entrances 51 through 53.

The detector 100 may include a first detector 110 and second detector 120. The first detector 110 may be provided at a vehicle entrance of the parking area 20 and may detect when the target vehicle enters the parking area 20. For example, the first detector 110 may be installed at a vehicle entry barrier 40 to detect the target vehicle passing through the vehicle entrance.

The second detector 120 may detect the target vehicle moving within the parking area 20 and the other vehicles parked in the parking area 20. A plurality of second detectors 120 may be provided. The plurality of second detectors 120 may be arranged at different locations in the parking area 20 to detect the target vehicle and the other vehicles within their respective detection ranges.

The notifier 300 may guide the target vehicle to the parking space recommended by the management processor 200. The notifier 300 may include first notifiers 310 and second notifiers 320. The first notifiers 310 may be installed in the respective parking spaces 30 provided in the parking area 20 and may irradiate light in a preset color or pattern. For example, the first notifiers 310 may be installed on the floors or the ceilings of the respective parking spaces 30.

In response to receipt of a notification control command from the management processor 200, the first notifier 310 may irradiate blue light or a blinking light. The driver of the target vehicle may easily identify the recommended parking space by referring to the color or pattern of the light irradiated by the first notifiers 310.

Additionally, the first notifiers 310 may irradiate different colors of light depending on whether vehicles are parked in the respective parking spaces 30. For example, the first notifiers 310 may irradiate red light when the respective parking spaces 30 are occupied, and irradiate green light when the parking spaces 30 are vacant.

A determination may be made as to whether vehicles are parked in the parking spaces 30 by the management processor 200 analyzing an image captured by the detector 100. The second detector 120 may capture a real-time video of the parking area 20 and transmit it to the management processor 200. The management processor 200 may identify the parking status of each parking space 30 based on the received video, and control the operation of the first notifiers 310 accordingly. In an embodiment, the second notifiers 320 may be built into or provided adjacent to the first notifiers 310. For example, each parking space 30 may be provided with both a first notifier 310 and a second detector 120. In this example, the first notifier 310 may irradiate light to indicate the parking status of the corresponding parking space 30 based on the detection result from the second detector 120, independently of the control by the management processor 200.

The second notifiers 320 may irradiate light onto the ground of the parking area 20 to indicate the parking space recommended by the management processor 200. For example, beam projectors may serve as the second notifiers 320. The second notifiers 320 may each form a road surface pattern in the form of letters, numbers, or figures on the ground of the parking area 20. The driver of the target vehicle may easily identify the recommended parking space by referring to the road surface pattern formed by each of the second notifiers 320.

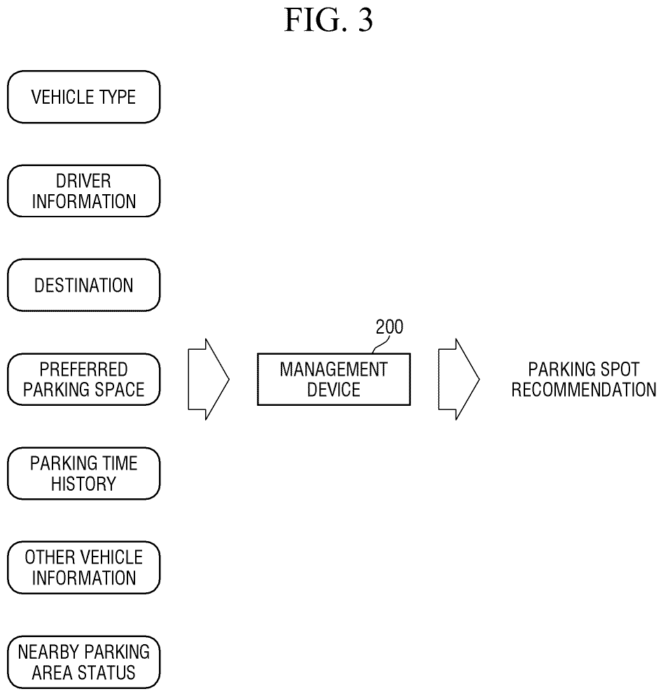

FIG. 3 is a view for explaining the operation of the management processor according to an embodiment.

Referring to FIG. 3, the management processor 200 may recommend (e.g., identify) a parking space for the target vehicle with reference to vehicle type, driver information, destination, preferred parking space, parking time, other vehicle information, and nearby parking area status.

The above-described parking information of the target vehicle may include at least one of the vehicle type of the target vehicle, driver information of the target vehicle, destination of the target vehicle, preferred parking space of the target vehicle, and parking time history of the target vehicle, and the above-described parking information of the other vehicles may include a parking time history of the other vehicles. Here, the vehicle type may include at least one of a sedan, hatchback, wagon, sports utility vehicle (SUV), crossover utility vehicle (CUV), coupe, multi-purpose vehicle (MPV), and truck. The parking information of the target vehicle may include an indication of the vehicle type of the target vehicle. The driver information may include at least one of the gender, age, and health status of the driver of the target vehicle. The destination of the target vehicle may include places that are frequently visited from the parking area 20, such as the residence or workplace of the driver of the target vehicle. The preferred parking space of the target vehicle may include one or more parking spaces 30 in the parking area 20 where the driver of the target vehicle prefers to park. The parking time history of the target vehicle may include the entry and exit times of the target vehicle into and out of the parking area 20. For example, the entry and exit times from the day the target vehicle first parked in the parking area 20 until the present, or from a specific past date until the present, may be included in the parking time history of the target vehicle.

The parking time history of the other vehicles may include the entry and exit times of the other vehicles into and out of the parking area 20. For example, the entry and exit times from the day the other vehicles first parked in the parking area 20 until the present, or from a specific past date until the present, may be included in the parking time history of the other vehicles.

The nearby parking area status refers to the parking status of parking areas 20 adjacent to the parking area 20 that the target vehicle has entered. As will be described later, the management processor 200 may receive detection results from detectors 100 provided in multiple parking areas 20 and may check the parking status for each of the multiple parking areas 20. If there is no suitable parking space in the parking area 20 that the target vehicle has entered, the management processor 200 may guide the driver of the target vehicle to a nearby parking area 20. For example, the management processor 200 may provide guidance on a route to a nearby parking area 20 through the user terminal 400 of the driver of the target vehicle.

The management processor 200 may recommend a parking space for the target vehicle by comprehensively referring to the parking information of the target vehicle, the parking information of the other vehicles, and the nearby parking area status. For example, when a plurality of parking spaces 30 are available in the parking area 20, the management processor 200 may recommend a parking space that accommodates the target vehicle safely, is close to the destination, and minimizes potential friction with the drivers of the other vehicles. Through such recommendation by the management processor 200, the driver of the target vehicle may easily park at an optimal parking space.

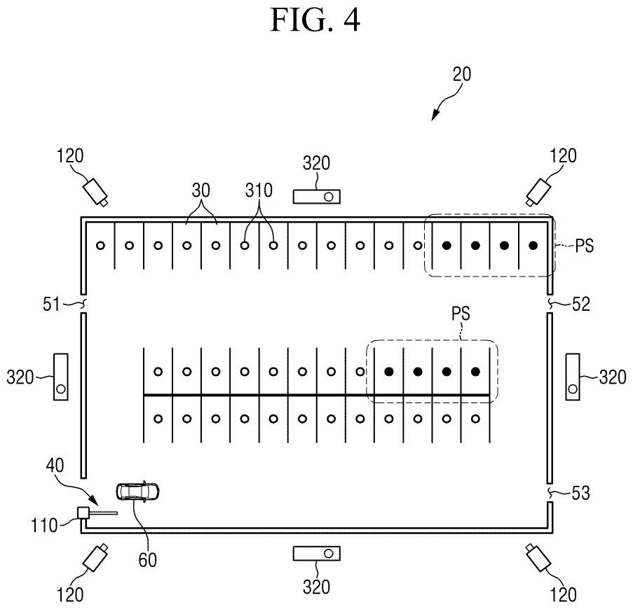

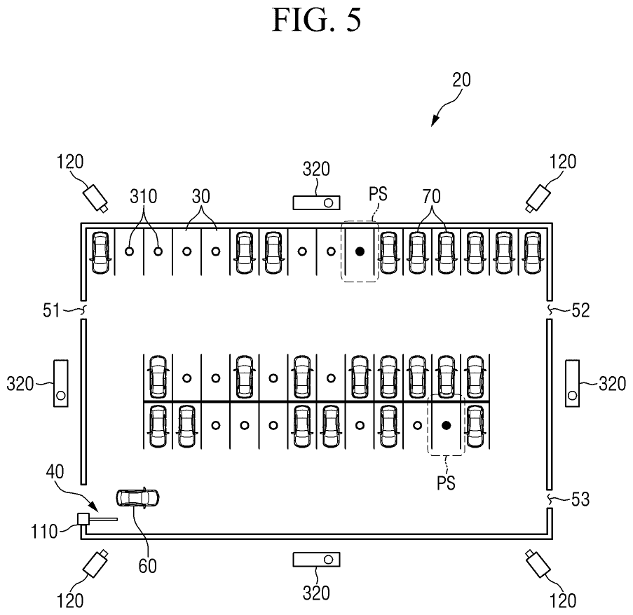

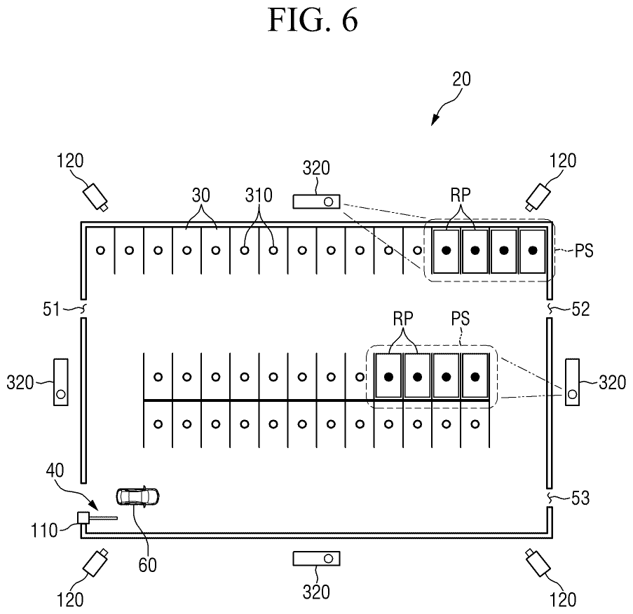

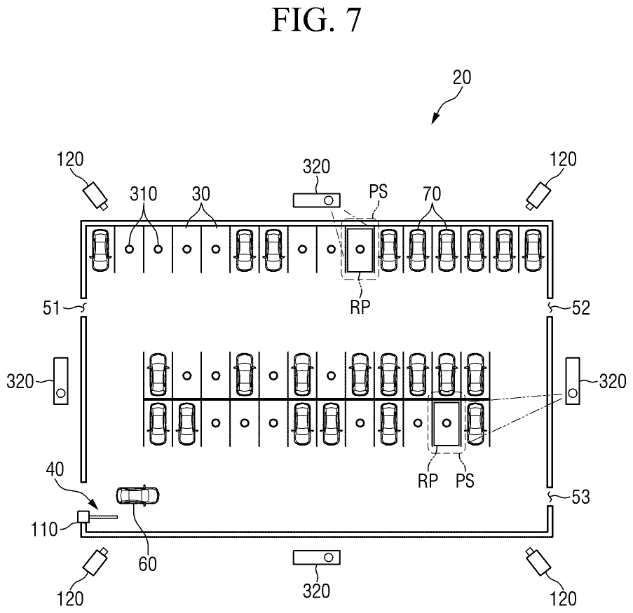

FIG. 4 is a view for explaining guidance to a parking space using the first notifiers 310 when there are no other vehicles according to an embodiment, FIG. 5 is a view for explaining guidance to a parking space using the notifiers 310 when other vehicles are present according to an embodiment, FIG. 6 is a view for explaining guidance to a parking space using the second notifiers 320 when there are no other vehicles according to an embodiment, and FIG. 7 is a view for explaining guidance to a parking space using the second notifiers 320 when other vehicles are present according to an embodiment.

Referring to FIGS. 4 and 5, when a target vehicle 60 enters the parking area 20, the first notifiers 310 may irradiate light in a preset color or pattern.

When the target vehicle 60 enters a parking area 20, the management processor 200 may analyze parking information of the target vehicle 60 and parking information of other vehicles 70, and recommend optimal parking spaces PS for the target vehicle 60 based on the result of the analysis. At least one parking space PS may be recommended by the management processor 200.

The parking area 20 may include a plurality of first through third pedestrian entrances 51 through 53. Referring to FIGS. 4 and 5, if the driver of the target vehicle 60 usually enters and exits through the second pedestrian entrance 52, the management processor 200 may recommend parking spaces 30 adjacent to the second pedestrian entrance 52 as the parking spaces PS. Based on the recommendation by the management processor 200, the first notifiers 310 may irradiate light in a preset color or pattern to inform the driver of the target vehicle 60. The driver of the target vehicle 60 may move to, and park the target vehicle 60, in one of the parking spaces 30 where the first notifiers 310 irradiate light in the specific color or pattern.

Referring to FIGS. 6 and 7, when the target vehicle 60 enters the parking area 20, the second notifiers 320 may irradiate light onto the ground of the parking area 20 to indicate the parking spaces PS recommended by the management processor 200.

The second notifiers 320 may indicate, using road surface patterns RP, where the target vehicle 60 is supposed to be positioned within a parking space 30 or a double-parking space in the parking area 20. The road surface patterns RP may be rectangles, but the shape of the road surface patterns RP formed by the second notifiers 320 is not particularly limited. For example, the shape of the road surface patterns RP may be predetermined, or may be determined to correspond to a shape of the target vehicle 60. The driver of the target vehicle 60 may move to, and park the target vehicle 60 in, one of the locations where the road surface patterns RP are formed, within the road surface patterns RP.

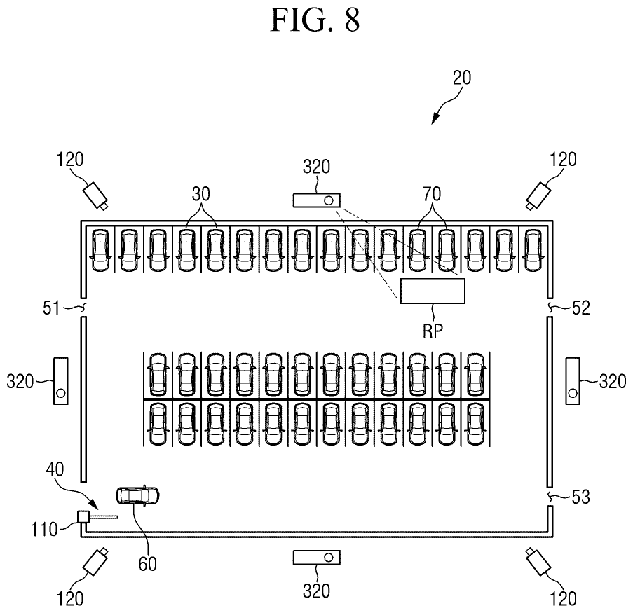

FIG. 8 is a view for explaining guidance to a parking space using the second notifiers according to an embodiment.

Referring to FIG. 8, the second notifiers 320 may form a road surface pattern RP to indicate a recommended parking space PS in a double-parking area.

When the target vehicle 60 enters the parking area 20, all parking spaces 30 may already be occupied by the other vehicles 70, or only parking spaces 30 that are not preferred by the driver of the target vehicle 60 may be available. In such a case, the management processor 200 may recommend a double-parking space as a parking space PS. At this time, the management processor 200 may analyze the parking information of the target vehicle 60 and the parking information of all the other vehicles 70 to determine an optimal double-parking space. For example, the management processor 200 may recommend a double-parking space adjacent to the second pedestrian entrance 52, which the driver of the target vehicle 60 frequently uses, as a parking space PS.

Additionally, the management processor 200 may refer to the parking time histories of the target vehicle 60 and the other vehicles 70 to calculate the expected departure times of the target vehicle 60 and the other vehicles 70, respectively. Then, the management processor 200 may recommend a double-parking space adjacent to another vehicle 70 whose expected departure time is later than that of the target vehicle 60. Since the other vehicle 70 is expected to depart later than the target vehicle 60, the driver of the target vehicle 60 may perform double parking with confidence.

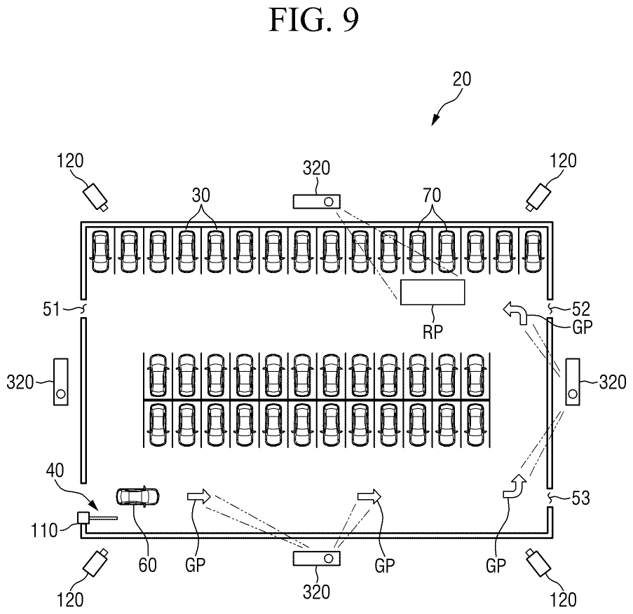

FIG. 9 is a view for explaining formation of a guide pattern on the ground of the parking area according to an embodiment.

Referring to FIG. 9, the second notifiers 320 may irradiate light onto the ground of the parking area 20 to form at least one guide pattern GP in the form of letters, numbers, or figures to guide the target vehicle 60 to a recommended parking space PS.

The road surface pattern RP indicating the recommended parking space PS may not be easily visible to the driver of the target vehicle 60. In this case, at least some of the second notifiers 320 provided in the parking area 20 may form the guide pattern GP. For example, the guide pattern GP may be provided in the shape of an arrow. The driver of the target vehicle 60 may refer to the guide pattern GP formed on the ground to move to the parking space PS easily.

FIG. 9 illustrates an example in which the guide pattern GP is formed only using an arrow, but according to some embodiments, the guide pattern GP may include a phrase indicating the target vehicle 60. For example, the guide pattern GP may include the vehicle number of the target vehicle 60 along with the arrow. When multiple target vehicles 60 enter the parking area 20, the drivers of the multiple target vehicles 60 may distinguish the guide patterns GP intended for them from the guide patterns GP intended for other drivers by referring to the vehicle numbers included in the guide patterns GP and move to the corresponding parking spaces PS.

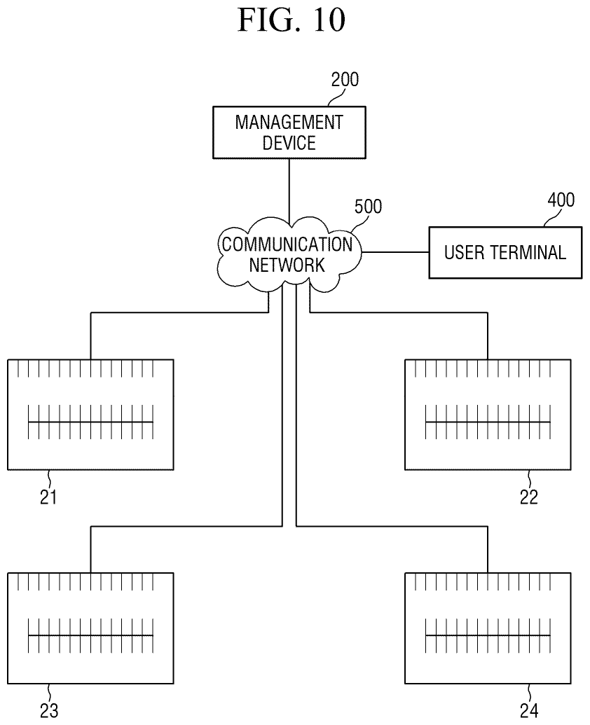

FIG. 10 is a view for explaining how the management processor manages multiple parking areas according to an embodiment.

Referring to FIG. 10, the management processor 200 may recommend a parking space PS included in one of a plurality of first through fourth parking areas 21 through 24 by referring to parking information of other vehicles 70 parked in the first through fourth parking areas 21 through 24.

The management processor 200 may communicate with a plurality of detectors 100 and a plurality of notifiers 300 provided in the first through fourth parking areas 21 through 24. To this end, the communication network 500 may relay communication between the management processor 200 and the plurality of notifiers 300 provided in the first through fourth parking areas 21 through 24.

When the target vehicle 60 has entered the first parking area 21, there may be no optimal parking space PS for the driver of the target vehicle 60 in the first parking area 21. In such a case, the management processor 200 may refer to detection results from the detectors 100 of the second through fourth parking areas 22 through 24, and select one of the second through fourth parking areas 22 through 24.

When one of the first through fourth parking areas 21 through 24 is selected, the management processor 200 may guide the driver of the target vehicle 60 to move to the selected parking area via the user terminal 400. For example, the management processor 200 may transmit a route to the selected parking area to the user terminal 400. When the target vehicle 60 enters the selected parking area, the management processor 200 may determine an optimal parking space PS for the driver of the target vehicle 60 and provide guidance to the parking space PS using the notifier 300 provided in the selected parking area.

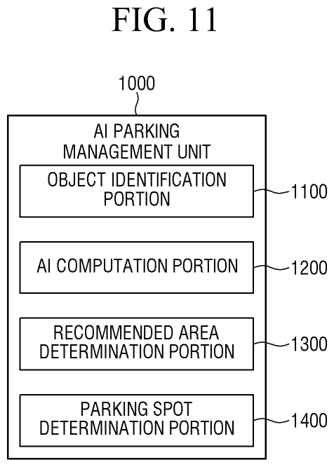

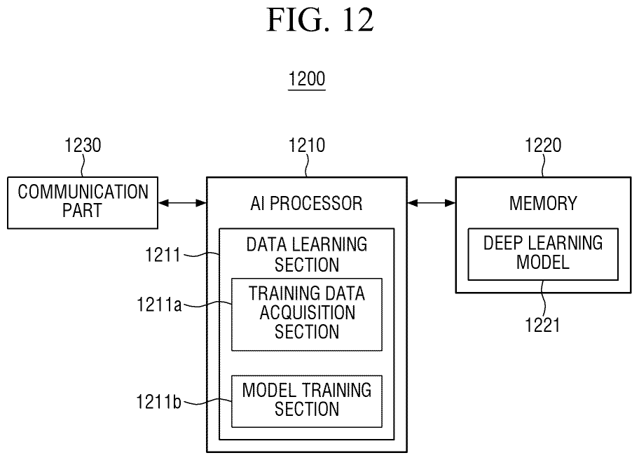

FIG. 11 is a block diagram of an artificial intelligence (AI) parking manager according to an embodiment, and FIG. 12 is a block diagram of an artificial intelligence computer according to an embodiment.

The aforementioned detector(s) 100 may include an AI parking manager 1000. The AI parking manager 1000 may be provided in a second detector 120. According to some embodiments, the AI parking manager 1000 may be provided in the management processor 200. The following description will primarily focus on an embodiment in which the AI parking manager 1000 is provided in a second detector 120.

The AI parking manager 1000 may recommend one of the first through fourth parking areas 21 through 24 through AI computation based on the parking information of the target vehicle 60. For example, the AI parking manager 1000 may input the parking information of the target vehicle 60 into a trained neural network model. The AI parking manager 1000 may recommend a parking area that promotes convenience for the driver of the target vehicle 60 from among the first through fourth parking areas 21 through 24.

In an embodiment of the present disclosure, the first through fourth parking areas 21 through 24 may be included within a defined spatial area. For example, the first through fourth parking areas 21 through 24 may be multiple parking lots in a single building, or multiple parking lots in adjacent buildings. The first through fourth parking areas 21 through 24 may be preset by a user.

The AI parking manager 1000 may include an object identifier 1100, an AI computer 1200, a recommended area determinator 1300, and a parking space determinator 1400.

The object identifier 1100 may identify objects included in an image captured by the second detector 120. Here, the term “object” refers to an entity that is included in an image, is distinguishable from the background, and has an independent movement, such as a person or item. The identification of such objects may be performed by a deep learning algorithm of the AI computer 1200.

The objects identified by the object identifier 1100 may generally be defined by object identification information, object type, object probability, and object size. The object identification information refers to arbitrary information indicating the identity of the objects, and the object type refers to a class distinguishable by humans, such as persons, animals, or vehicles. The object probability indicates the accuracy with which the objects are properly identified. For example, if the type and object probability of a specific object are a person and 80%, respectively, it means that the probability of the specific object being a person is 80%.

Referring to FIGS. 11 and 12, the AI computer 1200 may perform AI processing for the object identification operation of the object identifier 1100.

The AI computer 1200, which is a computing device capable of training a neural network, may be implemented in various electronic device forms such as a server, desktop PC, notebook PC, or tablet PC.

The AI computer 1200 may include an AI processor 1210, a memory 1220, and a communication interface 1230.

The AI processor 1210 may train a neural network using a program stored in the memory 1220. For example, the AI processor 1210 may train a neural network for recognizing objects from an image. Here, the neural network for recognizing objects from an image may be designed to simulate the structure of the human brain on a computer and include a plurality of network nodes with weights simulating neurons of the human nervous system. The plurality of network nodes may exchange data according to their connection relationships to simulate the synaptic activities of the neurons. Here, the neural network may include a deep learning model developed from a neural network model. In the deep learning model, the plurality of network nodes may be located in different layers and exchange data according to their convolutional connections. Examples of the neural network model include various deep learning techniques such as a deep neural network (DNN), convolutional neural network (CNN), recurrent neural network (RNN), restricted Boltzmann machine (RBM), and deep belief network (DBN). Deep Q-Networks may be applied to fields such as computer vision, speech recognition, natural language processing, voice processing, and signal processing.

The AI processor 1210 performing such functions may be implemented as at least one of a general-purpose processor (e.g., CPU) and/or an AI-dedicated processor (e.g., GPU). The memory 1220 stores various programs and data required for the operation of the AI computer 1200. The memory 1220 may be implemented as non-volatile memory, volatile memory, flash memory, hard disk drive (HDD), or solid-state drive (SSD). The memory 1220 is accessed by the AI processor 1210, and the reading, writing, editing, deletion, and updating of data by the AI processor 1210 are performed. The memory 1220 may store a neural network model 1221 (e.g., a deep learning model) generated through a learning algorithm for classification and recognition of data according to an embodiment.

The AI processor 1210 may include a data learner 1211 for training a neural network for data classification and recognition. The data learner 1211 may learn which training data to use for classifying and recognizing data and the criteria for classifying and recognizing data using the training data. The data learner 1211 may acquire training data and train the deep learning model 1221 by applying the acquired training data to the deep learning model 1221.

The data learner 1211 may be manufactured in the form of at least one hardware chip and mounted in the AI computer 1200. For example, the data learner 1211 may be fabricated as an artificial intelligence-dedicated hardware chip. The data learner 1211 may be fabricated as part of a general-purpose processor (CPU) or dedicated graphics processor (GPU) and mounted in the AI computer 1200. In an embodiment, the data learner 1211 may be implemented as software. If the data learner 1211 is implemented as a software module (or program module including instructions), the software module may be stored in a computer-readable medium. In this case, at least one software module may be provided by an operating system (OS) or application.

The data learner 1211 may include a training data acquirer 1211a and a model trainer 1211b.

The training data acquirer 1211a may acquire training data requested for the neural network model used for data classification and recognition. For example, the training data acquirer 1211a may acquire at least one of objects and sample data to be input as training data to the neural network model.

The model trainer 1211b may train the neural network model to include criteria for how to classify data using the acquired training data. In this case, the model trainer 1211b may train the neural network model through supervised learning using at least some of the training data as criteria. In an embodiment, the model trainer 1211b may use unsupervised learning to allow the neural network model to self-learn without supervision and discover classification criteria. Furthermore, the model trainer 1211b may train the neural network model using reinforcement learning with feedback on the accuracy of learning-based inference results. The model trainer 1211b may also use a training algorithm including a backpropagation method or a gradient descent method to train the neural network model.

Once the neural network model is trained, the model trainer 1211b may store the trained neural network model in the memory 1220. The model trainer 1211b may also store the trained neural network model in a memory 1220 of a server connected to the AI computer 1200 via a wired or wireless network.

The communication interface 1230 may output the results of processing by the AI processor 1210. The communication interface may include any one or any combination of a digital modem, a radio frequency (RF) modem, an antenna circuit, a WiFi chip, and related software and/or firmware.

Referring again to FIG. 11, the recommended area determinator 1300 may recommend one of the first through fourth parking areas 21 through 24 by performing AI computation on parking information of the target vehicle 60, identified by the object identifier 1100.

The parking information of the target vehicle 60 may include at least one of the vehicle type of the target vehicle 60, driver information of the target vehicle 60, destination of the target vehicle 60, preferred parking space of the target vehicle 60, and parking time history of the target vehicle 60. The parking information of the target vehicle 60 has already been described above, and thus, a detailed explanation thereof will be omitted.

The parking space determinator 1400 may determine the parking space of the target vehicle 60 by tracking the target vehicle 60 identified by the object identifier 1100. The target vehicle 60 that has entered a parking area may park at a specific location. Then, the parking space determinator 1400 may determine the parking space of the target vehicle 60 with reference to tracking information of the target vehicle 60.

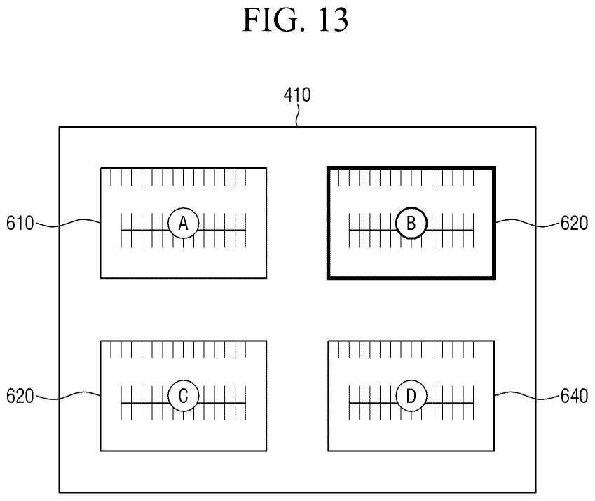

FIG. 13 is a view illustrating a screen of a user terminal indicating a recommended parking area according to an embodiment.

Referring to FIG. 13, the user terminal 400 may output a parking area recommended by the AI parking manager 1000.

FIG. 13 illustrates that thumbnails 610, 620, 630, and 640 corresponding to the first, second, third, and fourth parking areas 21, 22, 23, and 24, respectively, included in a defined spatial area are output on a screen 410 of the user terminal 400. For example, the user terminal 400 may access a webpage provided by the AI parking manager 1000. In this example, the webpage may provide the thumbnails 610, 620, 630, and 640 of the first, second, third, and fourth parking areas 21, 22, 23, and 24, and the screen 410 of the user terminal 400 may output the thumbnails 610, 620, 630, and 640. FIG. 13 depicts the thumbnails 610, 620, 630, and 640 of the first, second, third, and fourth parking areas 21, 22, 23, and 24 being output on the screen 410 of the user terminal 400.

When a parking area is recommended from the AI parking manager 1000, the recommended parking area may be displayed on the screen 410 of the user terminal 400. For example, when the second parking area 22 is recommended, edges or the entire area of the thumbnail 620 corresponding to the second parking area 22 may be highlighted in a specific color. The user may confirm the recommended parking area through the highlighted thumbnail 620.

When the AI parking manager 1000 recommends a parking area, the user may determine whether to select the recommended parking area as a preferred parking area. The user may select either the parking area recommended by the AI parking manager 1000 or a separate parking area as a preferred parking area. The selection of a preferred parking area may be made by accessing the webpage provided by the AI parking manager 1000.

Information regarding the user's preferred parking area may be transmitted to the AI parking manager 1000. When the user accesses the webpage, the AI parking manager 1000 may allow a thumbnail corresponding to the preferred parking area to be highlighted on the screen 410 of the user terminal 400.

When the preferred parking area is selected by the user, the management processor 200 may provide information for guiding the target vehicle 60 to the preferred parking area through the user terminal 400 from among the first through fourth parking areas 21 through 24. For example, the management processor 200 may transmit a route from the current location of the target vehicle 60 to the preferred parking area to the user terminal 400. The user terminal 400 may output the received route from the management processor 200, and the user may confirm the preferred parking area based on the output route.

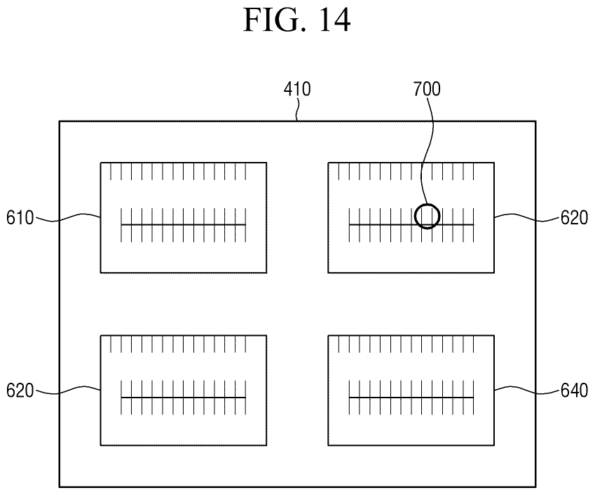

FIG. 14 is a view illustrating a screen of a user terminal indicating the parking space of the target vehicle according to an embodiment.

Referring to FIG. 14, the user terminal 400 may output a parking space provided by the AI parking manager 1000.

The AI parking manager 1000 may provide information on the parking space in which the target vehicle 60 is parked through AI computation for the target vehicle 60. The AI parking manager 1000 may continuously track the target vehicle 60 and identify the parking space of the target vehicle 60. When a request for confirmation of the parking space of the target vehicle 60 is received via the user terminal 400, the AI parking manager 1000 may transmit the information on the corresponding parking space to the user terminal 400.

The parking space of the target vehicle 60 may be displayed on the screen 410 of the user terminal 400. For example, as illustrated in FIG. 14, an icon 700 of a certain shape may be displayed in an area of the thumbnail 620 corresponding to the second parking area 22, at a location corresponding to the parking space of the target vehicle 60. A letter string (not illustrated) indicating the parking space may also be displayed together with the icon 700. For example, the letter string “B-15” may be displayed along with the icon 700. Through this, the user may confirm that their vehicle is parked in the fifteenth parking space in the second parking area 22.

According to the parking management system and method of the present disclosure, since a driver is guided to a parking space in consideration of their parking preference, there is an advantage in that the driver can park the vehicle more easily and conveniently.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A parking management system comprising:
a detector configured to detect a target vehicle that enters a parking area and one or more other vehicles parked in the parking area; and
a management processor configured to identify a parking space for the target vehicle based on parking information of the target vehicle and parking information of the one or more other vehicles.

2. The parking management system of claim 1, wherein the detector comprises:
a first detector at a vehicle entrance of the parking area and configured to detect the target vehicle entering the parking area; and
a second detector configured to detect the target vehicle moving within the parking area and the one or more other vehicles parked in the parking area.

3. The parking management system of claim 1, wherein the parking information of the target vehicle comprises at least one of a vehicle type of the target vehicle, driver information of the target vehicle, a destination of the target vehicle, a preferred parking space of the target vehicle, or a parking time history of the target vehicle, and
wherein the parking information of the one or more other vehicles comprises a parking time history of the one or more other vehicles.

4. The parking management system of claim 3, wherein the management processor is further configured to:
determine an expected departure time of the target vehicle and an expected departure time of the one or more other vehicles based on the parking time history of the target vehicle and the parking time history of the one or more other vehicles, respectively; and
identify, as the parking space, a double-parking space adjacent to a vehicle that has an expected departure time later than the expected departure time of the target vehicle, among the one or more other vehicles.

5. The parking management system of claim 1, further comprising:
a notifier configured to provide guidance to the parking space,
wherein the notifier comprises:
a first notifier installed in each of a plurality of parking spaces provided in the parking area and configured to irradiate light in a preset color or pattern; and
a second notifier configured to irradiate light onto a ground of the parking area corresponding to the parking space.

6. The parking management system of claim 5, wherein the second notifier is further configured to irradiate, in a form of a figure, an area within a parking space or a double-parking space in the parking area at which the target vehicle is to be positioned.

7. A parking management system comprising:
an artificial intelligence (AI) parking manager configured to identify a parking area of a plurality of parking areas by using a trained neural network model based on parking information of a target vehicle; and
a user terminal configured to output the identified parking area.

8. The parking management system of claim 7, wherein the parking information of the target vehicle comprises at least one of a vehicle type of the target vehicle, driver information of the target vehicle, a destination of the target vehicle, a preferred parking space of the target vehicle, or a parking time history of the target vehicle.

9. The parking management system of claim 7, wherein the AI parking manager is further configured to provide information about a parking space at which the target vehicle is parked.

10. The parking management system of claim 7, further comprising:
a management processor configured to provide information for guiding the target vehicle to a parking area selected from among the plurality of parking areas through the user terminal.

11. A parking management method comprising:
detecting a target vehicle that enters a parking area and one or more other vehicles parked in the parking area; and
identifying a parking space for the target vehicle based on parking information of the target vehicle and parking information of the one or more other vehicles.

12. The parking management method of claim 11, wherein the detecting the target vehicle comprises:
detecting the target vehicle entering the parking area; and
detecting the target vehicle moving within the parking area.

13. The parking management method of claim 11, wherein the parking information of the target vehicle comprises at least one of a vehicle type of the target vehicle, driver information of the target vehicle, a destination of the target vehicle, a preferred parking space of the target vehicle, or a parking time history of the target vehicle, and
wherein the parking information of the one or more other vehicles comprises a parking time history of the one or more other vehicles.

14. The parking management method of claim 13, wherein the identifying the parking space for the target vehicle comprises:
determining an expected departure time of the target vehicle and an expected departure time of the one or more other vehicles based on the parking time history of the target vehicle and the parking time history of the one or more other vehicles, respectively; and
identifying, as the parking space, a double-parking space adjacent to a vehicle that has an expected departure time later than the expected departure time of the target vehicle, among the one or more other vehicles parked in the parking area.

15. The parking management method of claim 11, further comprising:
irradiating light in different colors based on whether the one or more other vehicles are parked in respective parking spaces among a plurality of parking spaces provided in the parking area; and
irradiating light onto a ground of the parking area corresponding to the parking space.

16. The parking management method of claim 15, wherein the irradiating light onto the ground of the parking area corresponding to the parking space comprises irradiating, in a form of a figure, an area within a parking space or a double-parking space in the parking area at which the target vehicle is to be positioned.

17. A parking management method comprising:
identifying one of a plurality of parking areas using a trained neural network based on parking information of a target vehicle; and
outputting the identified parking area.

18. The parking management method of claim 17, wherein the parking information of the target vehicle comprises at least one of a vehicle type of the target vehicle, driver information of the target vehicle, a destination of the target vehicle, a preferred parking space of the target vehicle, or a parking time history of the target vehicle.

19. The parking management method of claim 17, further comprising:
providing information about a parking space at which the target vehicle is parked.

20. The parking management method of claim 17, further comprising:
providing information for guiding the target vehicle to a parking area selected from among the plurality of parking areas through a user terminal.

21. The parking management system of claim 1, wherein the detector or the management processor comprises an artificial intelligence (AI) parking manager configured to identify a parking area of a plurality of parking areas by using a trained neural network model based on parking information of a target vehicle, and
wherein the system further comprises a user terminal configured to output the identified parking area.

22. The parking management system of claim 21, wherein the AI parking manager is further configured to provide information about a parking space at which the target vehicle is parked.

23. The parking management system of claim 21, wherein the management processor is further configured to provide information for guiding the target vehicle to a parking area selected from among the plurality of parking areas through the user terminal.
